(19) United States
(12) Patent Application Publication
(10) Pub. No.: US 2021/0050739 A1
(43) Pub. Date: Feb. 18, 2021

(54) SUPER CAPACITOR AIDED UNINTERRUPTED POWER SUPPLY DEVICE

(71) Applicant: Nero Endustri Savunma Sanayi Anonim Sirketi, Istanbul (TR)

(72) Inventor: Alican OKCUN, Ankara (TR)

(21) Appl. No.: 16/727,369

(22) Filed: Dec. 26, 2019

(30) Foreign Application Priority Data
Aug. 15, 2019 (TR) 2019/12300

(51) Int. Cl. H02J 9/00; G05F 1/66

(52) U.S. Cl. CPC H02J 9/002; G05F 1/66

(57) ABSTRACT

An uninterrupted power system for providing power to fire extinguishing systems of vehicles, and for providing continued operation without being influenced by the power supply. A micro processor controlled smart control circuit provided in the device tracks and controls the active power supply voltage of the systems continuously. In case the active power source voltage is above an upper threshold level or under a lower threshold level, it turns on and supplies the system via super capacitors. The action of turning on is automatically performed by the control circuit. In case voltage goes under the upper threshold level or above the lower threshold level, the system's power supply goes into on status immediately and it is checked in a specified time to determine whether or not such change arose from voltage fluctuations. If the change is stable during a lapsing period and is at normal voltage levels, the power source is restarted.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The invention relates to an uninterrupted power supply device providing protection for systems needing uninterrupted power supply, primarily, vehicle fire extinguishing systems from low/high voltage and fluctuations caused by unstable power supplies and permanent working of them without being affected by power cuts.

### 2. Description of Related Art Including Information Disclosed Under 37 CFR 1.97 and 37 CFR 1.98.

Super capacitors also known as electrochemical double layer capacitors. Though having lower power capacity in comparison to batteries, they are capable of receiving and transferring power faster when compared to batteries. Present super capacity uninterrupted power systems are designed to turn on at a specified voltage level. A capacitor is turned on and supplies power to the system when under the preset threshold voltage and power to the system through the capacitor is cut when at the preset threshold voltage. However, this situation causes on/off of the supplied systems due to reduction/increase in voltage constantly in case of voltage fluctuation that might occur, and thus results in instability of systems and prevents healthy operation thereof

The application numbered TR2017/10972 of the prior art discloses a super capacitor mechanism for portable electronics devices and a method for operation thereof. In this context, it discloses a portable electronics device comprising a casing comprising a main circuit card paving at least a super capacitor mechanism. In addition, it provides a method for operation of a portable electronics device comprising a removable and rechargeable battery and a position detection module such as a GPS receiver and a radio frequency telecommunication module such as a cellular phone receiver-transmitter. For that reason, even when the battery is removed from the device or if battery is dead, it can be used to find out the device location and transmit it by use of electricity supplied by super capacitor. As seen, it does not seem possible to get benefit in respect to providing uninterrupted power supply to the system where it is connected in case of voltage drops or fluctuations in case of dead battery or removal thereof for turning super capacitor.

As a result, due to above-described disadvantages and inadequacy of existing solutions it has been necessary to make development in the related art.

### BRIEF SUMMARY OF THE INVENTION

The main purpose of the present invention is to disclose a device providing continuous operation of systems needing uninterrupted power supply without influence by voltage drops and fluctuations caused by unstable power sources. The invention prevents unstable operation of system by protecting from voltage fluctuations. Besides impacts of unreliable power supplies, in cases when the battery of a vehicle dies during operations made by military vehicles, the invention supplies power to the system and thus provides protection.

Software protection is provided from voltage fluctuations that might occur in certain tolerance ranges by use of a microprocessor instead of Op-Amp comparison circuits used in current super capacitor decision mechanisms.

Fire extinguishing and explosion suppressing systems are designed to protect vehicles against cases and threats that might be caused by RPG attacks to vehicles and other explosions causing cases. Such system detects explosions occurring as a result of RPG attacks in 3 ms, turns on systems in 6 ms and suppresses explosion in a period of 250 ms in total and prevents burning of personnel in the vehicle. Therefore, uninterrupted operation of the system increases chance of survival for personnel during operation. Use of said invention in systems wherein this and other types of uninterrupted operation are vital is necessary.

The structural and characteristic features and all advantages of the invention will be understood better in the figures given below and the detailed description by reference to the figures. Therefore, the assessment should be made based on the figures together with references to the detailed descriptions.

### BRIEF DESCRIPTION OF THE SEVERAL VIEWS OF THE DRAWINGS

FIG. 1 is a perspective view of the uninterrupted device of the invention in exploded form.

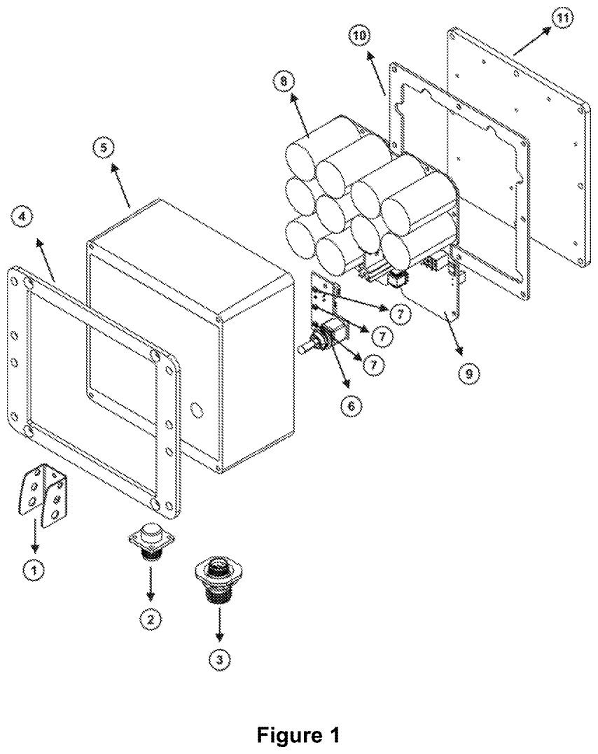

The drawings are not necessarily scaled and the details not necessary for understanding the present invention might have been neglected. In addition, the components which are equivalent to great extent at least or have equivalent functions at least have been assigned the same number.

### DESCRIPTION OF PART REFERENCES

1. Protective lid

2. Power output

3. Power input

4. Flange

5. Device body

6. Switch

7. Status light

8. Super capacitor

9. Control circuit

10. Leakproof gasket

11. Rear lid

### DETAILED DESCRIPTION OF THE INVENTION

In this detailed description, the preferred embodiments of the invention have been described without any restrictive effects but only for purpose of better understanding of the matter.

The device disclosed under the invention provides operation of systems needing uninterrupted power supply with no influence to be caused by power cuts, and primarily fire extinguishing systems. A micro processor controlled smart control circuit (9) provided in the device tracks and controls active power supply voltage of said systems continuously. Under the invention, two threshold voltage levels are observed. These levels are called the upper threshold level and the lower threshold level. The level between the upper and lower threshold voltage levels is referred to as normal operation voltage In case the active power source voltage is above the upper threshold level or under the lower threshold level, it turns on in a period of 1 ms and shorter time and supplies the system via the super capacitor (8) it comprises. The action of turning on is automatically performed by the control circuit (9). In case voltage goes under the upper threshold level or above the lower threshold level, the system's power supply goes into on status immediately and it is checked in a specified time to check whether or not such change arises from voltage fluctuations. If the change is stable during the lapsing time and is at normal voltage levels, the power source goes into on status in a 1 ms or shorter time period. Continued control by the device provides operation of the system without need for personnel.

Transition between the power source and the super capacitor (8) is provided by software decision mechanisms in the control circuit (9). In case of discharge of the super capacitor (8) or if it goes under a specified threshold voltage level, then the control circuit (9) is recharged via the power source of super capacitors (8). When the super capacitors (8) are fully charged, the control circuit (9) stops recharging automatically.

Components located on device body (5) are as follows:
Switch (6): Control power in the system (un/off). Thus it is ensured to conduct maintenance to be required in the unit (vehicle etc.) where the system is in a safe way and not causing any undesired activation by the system.
Protective lid (1): Is located around the switch (6) and functions as prevention of intervention that can be made to switch (6) without intention.
Status lights (7): Preferably LED light sources indicating whether the system is supplied by the power source or the super capacitors (8).
Leakproof gasket (10): Located between the device body (5) and the rear lid (11) and protecting the super capacitors (8) and the control circuit (9) against agents in the medium. Similarly it prevents entrance of electromagnetic waves into device body (5) and exit from device body (5).
Flange (4): Provides mounting device body (5) in the area where system is located.
Power output (2) and power input (3): Are the sockets where cable connections are made.

I claim:

1. An uninterrupted power device providing uninterrupted operation of fire extinguishing systems characterized by comprising a microprocessor controlled control circuit, the microprocessor controlled control circuit provided for:
tracking active power source voltage of system continuously;
turning on super capacitors contained therein to supply the system in case power source voltage is above an upper threshold level or under a lower threshold level;
controlling that voltage is between threshold values of said voltage for a certain time in order to prevent the misleading arising from voltage fluctuation and confirming thereof and supplying via power source; and
capable to charge super capacitors via power source.

2. The uninterrupted power device according to claim 1, characterized by comprising a switch located on the device body and turning the device on and off.

3. The uninterrupted power device according to claim 2, characterized by comprising a protective lid located around the switch in order to prevent undesired interventions.

4. The uninterrupted power device according to claim 1, characterized by comprising at least one status light showing whether it is operated by the power source or a super capacitors system comprising a power source or super capacitors.

5. The uninterrupted power device according to claim 1, characterized by comprising a leakproof gasket located between the device body and a rear lid and protecting the super capacitors and the control circuit against agents in the medium and preventing electromagnetic waves in the device body and preventing leave from the device body.
